(19) United States
(12) Patent Application Publication
(10) Pub. No.: US 2014/0190076 A1
(43) Pub. Date: Jul. 10, 2014

(54) VEGETATION GROWTH BAG AND METHOD OF USE

(71) Applicant: BRIAN WEINZAPFEL, Evansville, IN (US)

(72) Inventor: BRIAN WEINZAPFEL, Evansville, IN (US)

(21) Appl. No.: 13/735,011

(22) Filed: Jan. 6, 2013

(51) Int. Cl. A01G 9/02

(52) U.S. Cl. CPC A01G 9/02
USPC 47/65.8; 47/66.7

(57) ABSTRACT

A vegetation growth bag comprising a casing, where the casing is made from a biodegradable material; a mixture of organic matter within the casing; where the mixture of organic matter includes a plurality of plant seeds, where as the plant seeds grow they erupt through the casing; and a pair of closures at each end of the casing; where the pair of closures prevent the mixture of organic matter from spilling from the casing. During use the vegetation growth bags are arranged along a barren land area, and left to allow rain and sunlight to promote growth of the seeds within the casing. Eventually the vegetation growth bags incorporate themselves into the barren land area by allowing the roots to anchor the casing to the ground.

### BACKGROUND OF THE INVENTION

1. Field of the Invention

The present invention relates to a biodegradable bag filled with a combination of sand, seed, fertilizer and dirt to prevent erosion on the banks of rivers and streams.

2. Description of Related Art

It is common in areas such as ditch banks, hillsides, small creeks, and run off areas in fields and yards to erode after they have been excavated. Similarly, many banks along a river or stream are depleted of plant life after years of fluctuating water levels. The resulting land is barren with only hard soil and dirt remaining. New plants are often unable to grow in these areas because the ground lacks the necessary nutrients to promote healthy vegetation growth. Without intervention the land may remain barren or even spread in areas where loose dirt may cause the riverbank to further erode.

Typically to remedy the loss of vegetation in barren areas, seeding and straw mats are used to reestablish plant life. The mats are either impregnated with grass or grass seeds which brings an abundance of vegetation to an area. Over time the grasses may take root and reestablish the thriving plant life that was once in the area. Unfortunately, the mats often shift or wash away because the underlying dirt is either too hard or too soft to allow the grass roots to take hold. As such, sand bags are commonly used to anchor the grass mats thereby allowing them time to thrive and grow in the barren area. But a problem encountered with the sand bags is that sometimes they break down the mat, or they burst causing the internal soft sand to kill the new growth and repeat the cycle.

Therefore, it would be beneficial in the art to provide a vegetation growth system that incorporates a grass mat with a sand bag, to allow the grass mat to be independently anchored to the ground. It would also be desirable in the art to provide a vegetation growth system that enables growth of a variety of different types of plants depending on the natural growth surrounding the barren area.

### SUMMARY OF THE INVENTION

In view of the foregoing disadvantages inherent in the prior art, the general purpose of the present invention is to provide a sod bag to promote vegetation growth, configured to include all of the advantages of the prior art, and to overcome the drawbacks inherent therein.

Accordingly, an object of the present invention is to provide a vegetation growth bag that envelopes a mixture of sand, dirt, fertilizer and seed in a biodegradable casing.

Another object of the present invention is to utilize multiple vegetation growth bags to regrow plant life in a depleted area.

To achieve the above objects, in an aspect of the present invention, a vegetation growth bag is described comprising a casing, where the casing is made from a biodegradable material; a mixture of organic matter within the casing; where the mixture of organic matter includes a plurality of plant seeds, where as the plant seeds grow they erupt through the casing; and a pair of closures at each end of the casing; where the pair of closures prevent the mixture of organic matter from spilling from the casing. During use the vegetation growth bags are arranged along a barren land area, and left to allow rain and sunlight to promote growth of the seeds within the casing. Eventually the vegetation growth bags incorporate themselves into the ground by allowing the roots to anchor the casing.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a top view of a vegetation growth bag in accordance with an exemplary embodiment of the present invention;

FIG. 2 depicts a perspective view of a vegetation growth bag in accordance with an exemplary embodiment of the present invention;

FIG. 3 depicts a side view of a vegetation growth bag within a hole in accordance with an exemplary embodiment of the present invention; and

FIG. 4 depicts a perspective view of a plurality of vegetation growth bags on a river bank in accordance with an exemplary embodiment of the present invention.

Like reference numerals refer to like parts throughout the description of several views of the drawings.

### DETAILED DESCRIPTION OF THE DRAWINGS

The present invention relates to a biodegradable bag filled with a combination of sand, seed, fertilizer and dirt to prevent erosion on the banks of rivers and streams. The present invention provides a vegetation growth bag that basically combines a sand bag with a grass mat. Multiple vegetation growth bags may be aligned along a riverbank. As the seeds within the vegetation growth bags sprout and grow a layer of sod is formed along the riverbank thereby promoting plant growth and preventing loose soil from invading the nearby water. The vegetation growth bag may be available in various sizes to accommodate the size of the land area needing regrowth.

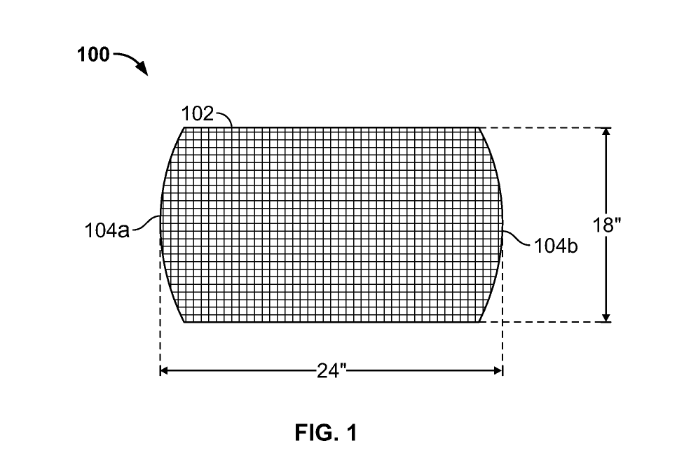

Turning now descriptively to the drawings, referring to FIG. 1, a top view of a vegetation growth bag 100 is shown in accordance with an exemplary embodiment of the present invention. The vegetation growth bag 100 is enveloped by a casing 102. The casing 102 may be a fabric that encases a mixture of organic matter. The casing 102 may be made from a biodegradable material like burlap or hessian. The mixture of organic matter may include materials such as dirt, soil, fertilizer, sand, and seeds. The seeds may be rye, grass, alfalfa, clover, ivy, flowering plants or underwater plants. The sand helps to anchor the casing 102 in place to prevent rolling or drifting while the seeds are growing. The fertilizer helps to promote initial plant growth, and then remains to nourish the underlying ground.

The casing 102 is enclosed with a pair of closures 104a, 104b, one at each end of the casing 102. The closures 104a, 104b ensure that the mixture of organic matter does not spill from the vegetation growth bag 100. The closures 104a, 104b may be sewn with biodegradable thread or yarn after the casing 102 is filled. The casing 102 comprises a generally rectangular form where when filled the casing 102 becomes a cylindrical shape. The dimensions of the casing 102 may range from 12-24 inches in width and 16-32 inches in length, where the preferred dimensions are 18 inches in width and 24 inches in length. The casing 102 is not filled to maximum capacity with the organic matter to allow for seed growth and expansion within the casing 102.

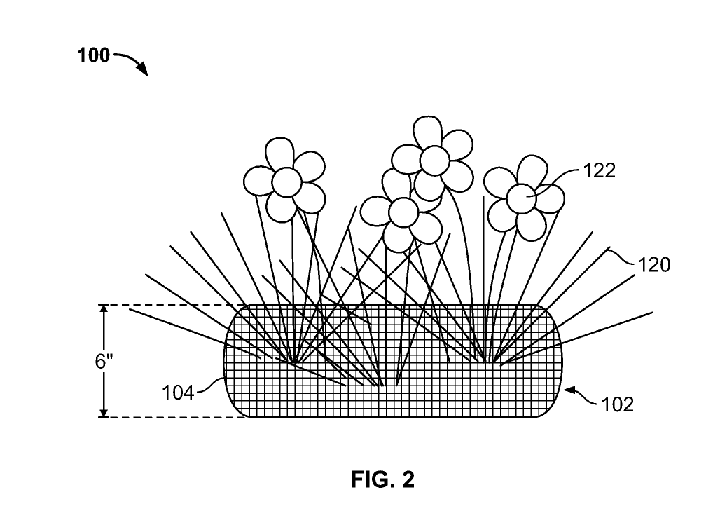

Referring now to FIG. 2 a perspective view of the vegetation growth bag 100 is shown in accordance with an exemplary embodiment of the present invention. The vegetation growth bag 100 is illustrated with a plurality of leaves 120 and flowers 122 sprouting from the casing 102. The biodegradable material that comprises the casing 102 is made from a thick weave of fabric. The thick weave of the fabric allows the plants growing from the seeds to sprout and grow through small holes between the fabric weave. This allows the grasses, leaves 120 and flowers 122 to grow upward while the roots of the plants grow down. The roots of the growing grasses 120 and flowers 122 may incorporate themselves into the underlying ground thereby providing an anchor for the vegetation growth bag 100.

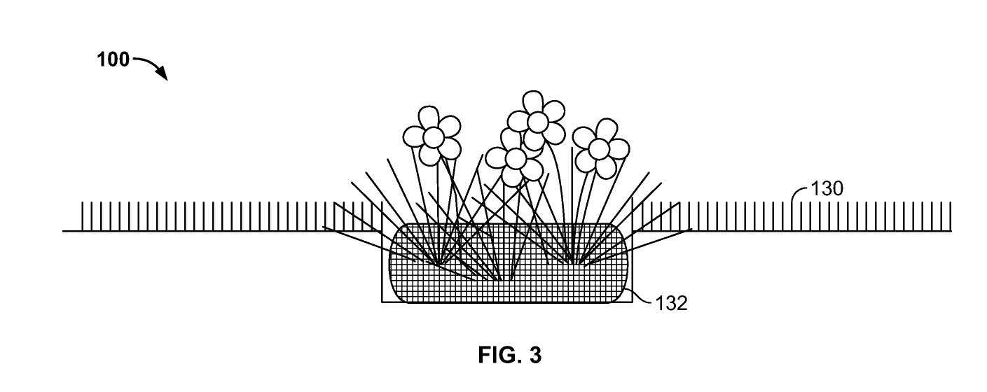

As seen in FIG. 3 a side view of the vegetation growth bag 100 is positioned within a hole 132. The vegetation growth bag 100 may fill in holes, dead patches, ditches and other areas where plant life is absent or dying. Plants of the vegetation growth bag 100 grow through the casing 102 and into the underlying ground. Thus the vegetation growth bag fills the holes 132 to even out the surrounding grass land 130.

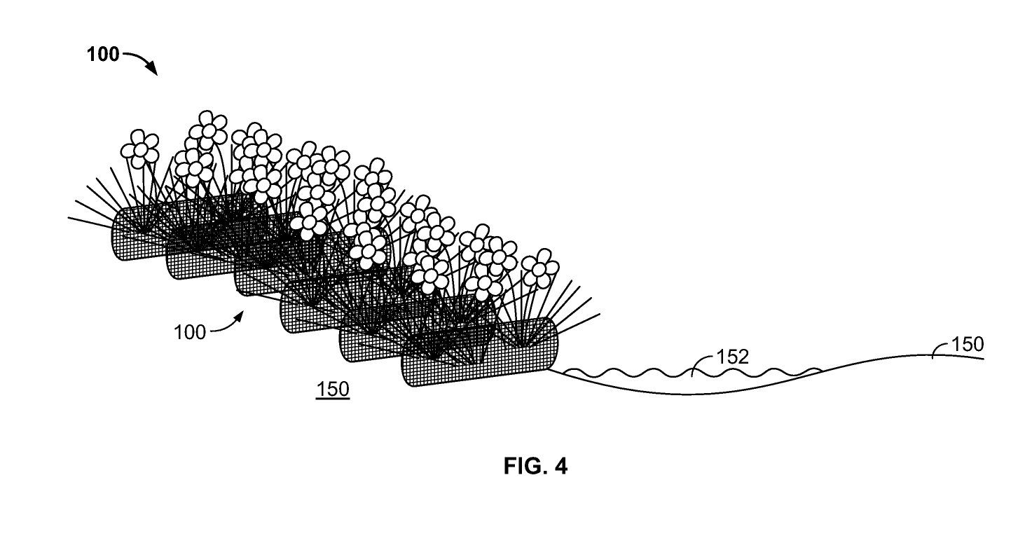

Referring now to FIG. 4, a perspective view of a plurality of vegetation growth bags 100 on a riverbank 150 are shown in accordance with an exemplary embodiment of the present invention. By arranging the plurality of vegetation growth bags 100 along the riverbank 150, plant life is reincorporated onto the banks of the river 152. The vegetation growth bags 100 prevent soil erosion and increase riverbank 150 vegetation growth. Depending on the location of the river 152 and the natural flora and fauna of the area, the type of seeds within the casing 102 changes to promote optimal plant growth success.

The vegetation growth bags are positioned along portions of the riverbank or other barren land areas that are lacking vegetation. The vegetation growth bags may be arranged proximal to each other, and in some areas overlapping for further plant growth. The vegetation growth bags are then left to rest while natural forces like rain and sun cast down upon the arranged vegetation growth bags. After a period of time the seeds within the casing start to sprout sending their leaves upward and their roots downward. As the seeds grow the leaves and roots erupt from the casing, allowing the leaves to continue growing while the roots imbed themselves within the ground. Eventually, the roots anchor the casing to the ground and incorporate the vegetation growth bag into the riverbank. The casing structurally supports the leaves and roots to stay in place and integrate into the ground. Over time, the casing may deteriorate leaving just the mixture of organic material which has become part of the natural vegetation.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A vegetation growth bag comprising:
a. a casing, where the casing is made from a biodegradable material;
b. a mixture of organic matter within the casing; where the mixture of organic matter includes a plurality of plant seeds, where as the plant seeds grow they erupt through the casing; and
c. a pair of closures at each end of the casing; where the pair of closures prevent the mixture of organic matter from spilling from the casing.

2. The vegetation growth bag according to claim 1, where the casing is made from a thick weave fabric.

3. The vegetation growth bag according to claim 2, where the biodegradable material is one of at least burlap and hessian.

4. The vegetation growth bag according to claim 1, where the mixture of organic matter further includes sand, soil, and fertilizer.

5. The vegetation growth bag according to claim 1, where the plurality of seeds are selected to adapt to a specific location where the vegetation growth bag is placed.

6. The vegetation growth bag according to claim 1, where the casing is placed within a hole where the vegetation growth bag incorporates itself into the hole by sprouting the plurality plant seeds and integrating a plurality of roots from the plant seeds into the ground within the hole.

7. A method of use for a vegetation growth bag comprising the steps of:
a. arranging a plurality of vegetation growth bags along a barren land area, where the vegetation growth bags are made from an biodegradable casing filled with a mixture of organic matter including plant seeds, dirt and fertilizer; and
b. leaving the plurality of vegetation growth bags to rest while rain and sunlight cast upon the vegetation growth bag to enable the plant seeds to grow, and incorporate the resulting plant leaves and roots from the plant seeds into the barren land area.

8. The method of use for the vegetation growth bag according to claim 7 further comprising the step of selecting a specific type of seed to adapt with a natural flora and fauna of the barren land area.
